(19) United States
(12) Patent Application Publication
(10) Pub. No.: US 2020/0173046 A1
(43) Pub. Date: Jun. 4, 2020

(54) ION EXCHANGE MEMBRANE AND ELECTROLYZER

(71) Applicant: ASAHI KASEI KABUSHIKI KAISHA, Tokyo (JP)

(72) Inventors: Atsushi NAKAJIMA, Tokyo (JP); Takuya MORIKAWA, Tokyo (JP)

(73) Assignee: ASAHI KASEI KABUSHIKI KAISHA, Tokyo (JP)

(21) Appl. No.: 16/671,535

(22) Filed: Nov. 1, 2019

(30) Foreign Application Priority Data
Nov. 5, 2018 (JP) 2018-208426
Oct. 4, 2019 (JP) 2019-183671

(51) Int. Cl. C25B 13/08; C25B 9/10; C08J 5/22

(52) U.S. Cl. CPC C25B 13/08; C25B 9/10; C08J 2427/18; C08J 5/2237; C08J 2327/18; C08J 5/2281

(57) ABSTRACT

[Problem to be solved] Provided is an ion exchange membrane having both excellent electrolytic characteristics and excellent gas zone damage resistance.

[Solution] An ion exchange membrane comprising:
a layer A comprising a fluorine-containing polymer having a sulfonic acid group; and
a layer B comprising a fluorine-containing polymer having a carboxylic acid group, wherein
the layer B has a thickness of 5 to 30 μm, and
the layer B has an ion cluster diameter of 1.8 to 2.48 μm.

### TECHNICAL FIELD

The present invention relates to an ion exchange membrane and an electrolyzer.

### BACKGROUND ART

Ion exchange membranes containing a fluorine-containing polymer have excellent heat resistance, chemical resistance, and the like, and are used in various applications as electrolytic membranes to be used in electrolyzers for alkali chloride electrolysis, ozone producing electrolysis, fuel cells, water electrolysis, hydrochloric acid electrolysis, and the like.

Among these, in alkali chloride electrolysis where chlorine and alkali hydroxide are produced in particular, the ion exchange membrane process is primarily used in recent years. The ion exchange membrane used in the electrolysis of alkali chloride is required to have various characteristics. For example, required are characteristics such as electrolytic characteristics that electrolysis can be performed at a high current efficiency and a low electrolytic voltage, and the concentration of impurities (such as alkali chloride in particular) contained in the produced alkali hydroxide is low, as well as membrane strength and like characteristics that the membrane strength is so high that no damage is incurred during membrane handling and electrolysis. While the voltage and current efficiency, which are electrolytic characteristics of an ion exchange membrane, are usually in a trade-off relationship, there are demands for the development of an ion exchange membrane having both characteristics at high levels.

In the vicinity of a gasket to be disposed in the upper portion of an electrolyzer, chlorine gas accumulating on the anode side reacts with alkali hydroxide on the cathode side inside the ion exchange membrane, and common salt precipitates inside the ion exchange membrane to thereby cause membrane damage (hereinafter, also simply referred to as “gas zone damage”). However, when the layer of a fluorine-containing polymer having a carboxylic acid group is made thinner in order to lower the voltage, there is a trade-off of occurrence of gas zone damage. Accordingly, it is generally thought to be difficult to achieve both electrolytic characteristics and a reduction in gas zone damage.

In view of the above problems, Patent Literatures 1 and 2 each propose an ion exchange membrane comprising at least two layers, i.e., a fluorine-containing polymer layer having a sulfonic acid group and a fluorine-containing polymer layer having a carboxylic acid group.

### CITATION LIST

### Patent Literature

[Patent Literature 1] International Publication No. WO 2016/186084

[Patent Literature 2] International Publication No. WO 2010/095740

### SUMMARY OF INVENTION

### Technical Problem

However, the ion exchange membrane described in Patent Literature 1 has room for further improvement from the viewpoint of damage on the membrane's upper portion in the vicinity of the gasket during electrolysis.

Patent Literature 2 describes an ion exchange membrane capable of reducing gas zone damage. However, a special molding processing apparatus is required, and moreover, there is still room for improvement from the viewpoint of the balance with the electrolytic characteristics.

The present invention has been conceived in view of the problems of the conventional art described above, and an object of the present invention is to provide an ion exchange membrane having both excellent electrolytic characteristics and excellent gas zone damage resistance.

### Solution to Problem

As a result of having conducted diligent research to solve the above problems, the present inventors found that electrolytic characteristics and gas zone damage resistance are dramatically improved by allowing an ion exchange membrane to have a specific layer structure and additionally by controlling the ion cluster diameter of a carboxylic acid layer, and accomplished the present invention.

That is to say, the present invention is as set forth below.

[1]

An ion exchange membrane comprising:

a layer A comprising a fluorine-containing polymer having a sulfonic acid group; and

a layer B comprising a fluorine-containing polymer having a carboxylic acid group, wherein

the layer B has a thickness of 5 to 30 μm, and

the layer B has an ion cluster diameter of 1.8 to 2.48 μm.

[2]

The ion exchange membrane according to [1], wherein the layer B has an ion exchange capacity of 0.76 to 1.30 mEq/g.

[3]

The ion exchange membrane according to [1] or [2], wherein

the layer A comprises a polymer of a compound represented by the following formula (2b); and

the layer B comprises a polymer of a compound represented by the following formula (3b):

CF₂═CF—(OCF₂CYF)_{c}—O—(CF₂)_{b}—SO₂M (2b)

wherein a represents an integer of 0 to 2, b represents an integer of 1 to 4, Y represents —F or —CF₃, and M represents an alkali metal; and

CF₂=CF—(OCF₂CYF)_{c}—O—(CF₂)_{d}—COOM (3b)

wherein c represents an integer of 0 to 2, d represents an integer of 1 to 4, Y represents —F or —CF₃, R represents —CH₃, —C₂H₅, or —C₃H₇, and M represents an alkali metal.
[4]

An electrolyzer comprising the ion exchange membrane according to any of [1] to [3].

### Advantageous Effects of Invention

The ion exchange membrane of the present invention has excellent gas zone damage resistance and electrolytic characteristics.

### BRIEF DESCRIPTION OF DRAWINGS

FIG. 1 shows a schematic cross-sectional view of one example of an ion exchange membrane of the present embodiment.

FIG. 2 shows a schematic view of one example of an electrolyzer of the present embodiment.

### DESCRIPTION OF EMBODIMENT

Below, an embodiment for carrying out the present invention (hereinafter referred to as “the present embodiment”) will now be described in detail. The present invention is not limited to the present embodiment below, and can be carried out after making various modifications within the scope of the present invention.

In the description of the drawings, the same or equivalent components will be indicated by the same reference numerals, and redundant description will be omitted. Positional relations such as upper, lower, left, and right positions in the drawings are based on positional relations depicted in the drawings unless otherwise specified, and dimension ratios of the drawings are not restricted to those as depicted. However, the drawings merely represent an example of the present embodiment, and the present embodiment is not to be construed as limited thereto.

An ion exchange membrane of the present embodiment has a layer A comprising a fluorine-containing polymer having a sulfonic acid group (hereinafter, sometimes simply referred to as a “layer A”) and a layer B comprising a fluorine-containing polymer having a carboxylic acid group (hereinafter, sometimes simply referred to as a “layer B”), wherein the layer B has a thickness of 5 to 30 μm, and the layer B has an ion cluster diameter of 1.8 to 2.48 nm. Being thus configured, the ion exchange membrane of the present embodiment has excellent electrolytic characteristics and gas zone damage resistance. As the action mechanism thereof, which is not limited to the following, it is believed that adjusting the ion cluster diameter of the layer B at a relatively small value leads to a reduction in the penetration rate of NaOH into the membrane and, as a result, gas zone damage on the layer A side becomes unlikely to occur. Gas zone damage on the layer B side tends to have a smaller influence on the gas zone damage resistance of the entire ion exchange membrane, in comparison with gas zone damage on the layer A side. Thus, it is believed that the structure described above improves the balance between the electrolytic characteristics and the gas zone damage resistance.

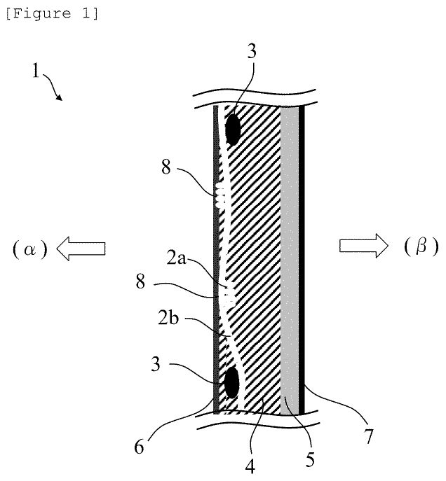

FIG. 1 shows a schematic cross-sectional view of one example of the configuration of the ion exchange membrane of the present embodiment. In the ion exchange membrane of the present embodiment, the layer 4 (layer A) containing a fluorine-containing polymer having a sulfonic acid group and the layer 5 (layer B) containing a fluorine-containing polymer having a carboxylic acid group are laminated, and there are reinforcement core materials 3 and continuous holes 2a and 2b inside the membrane. Normally, the layer 4 (layer A) containing a fluorine-containing polymer having a sulfonic acid group is disposed on the anode side a of the electrolyzer, and the layer 5 (layer B) containing a fluorine-containing polymer having a carboxylic acid group is disposed on the cathode side β of the electrolyzer. The membrane surface has coating layers 6 and 7. In FIG. 1, the continuous hole 2a and the reinforcement core materials 3 are formed perpendicular to the paper surface, and the continuous hole 2b is formed in the top-bottom direction of the paper surface. That is to say, the continuous hole 2b formed in the top-bottom direction of the paper surface is formed in a direction substantially perpendicular to the reinforcement core materials 3. The continuous holes 2a and 2b may have portions 8 that appear on the anode-side surface of the layer A. As shown in FIG. 1, the ion exchange membrane of the present embodiment is preferably laminated such that the surface of the layer A and the surface of the layer B are in contact. Hereinafter, the layer A and the layer B may be collectively referred to as a membrane body.

### [Layer A]

The layer A contained in the ion exchange membrane of the present embodiment contains a fluorine-containing polymer A having a sulfonic acid group (hereinafter sometimes simply referred to as a “polymer A”) and, particularly preferably, consists of the polymer A. Here, “the fluorine-containing polymer having a sulfonic acid group” refers to a fluorine-containing polymer having a sulfonic acid group or a sulfonic acid group precursor that can become a sulfonic acid group by hydrolysis. Other than the polymer A, the layer A may contain a polymer B, which will be described below, in a range of less than 20% by mass based on 100% by mass of the layer A, and preferably contains the polymer A in an amount of 80% by mass or more based on 100% by mass of the layer A.

The fluorine-containing polymer A having a sulfonic acid group, which constitutes the layer A, can be produced by, for example, copolymerizing a monomer of a first group and a monomer of a second group below, or homopolymerizing a monomer of a second group. In the case of being a copolymer, the polymer A may be a block polymer or may be a random polymer.

The monomer of the first group is not particularly limited and is, for example, a vinyl fluoride compound.

The vinyl fluoride compound is preferably a compound represented by the following general formula (1):

CF₂═CX₁X₂ (1)

wherein X₁ and X₂ each independently represent —F, —Cl, —H, or —CF₃.

The vinyl fluoride compound represented by the above general formula (1) is not particularly limited, and examples thereof include vinyl fluoride, tetrafluoroethylene, hexafluoropropylene, vinylidene fluoride, trifluoroethylene, and chlorotrifluoroethylene.

In particular, in the case of using the ion exchange membrane of the present embodiment as a membrane for alkali electrolysis, the vinyl fluoride compound is preferably a perfluoro monomer, more preferably a perfluoro monomer selected from the group consisting of tetrafluoroethylene and hexafluoropropylene, and even more preferably tetrafluoroethylene (TFE).

The monomers of the first group may be used singly or in combinations of two or more.

The monomer of the second group is not particularly limited and is, for example, a vinyl compound having a functional group that can be converted into a sulfonic acid-type ion exchange group.

The vinyl compound having a functional group that can be converted into a sulfonic acid-type ion exchange group is preferably a compound represented by the following general formula (2a):

CF₂═CF—(OCF₂CYF)ₐ—O—(CF₂)_{b}—SO₂F (2a)

wherein a represents an integer of 0 to 2, b represents an integer of 1 to 4, and Y represents —F or —CF₃.

In formula (2a), when a is 2, a plurality of Y are mutually independent.

The monomer of the second group is not particularly limited, and examples thereof include monomers shown below:
CF₂═CFOCF₂CF₂SO₂F,
CF₂═CFOCF₂CF(CF₃)OCF₂CF₂SO₂F,
CF₂═CFOCF₂CF(CF₃)OCF₂CF₂CF₂SO₂F,
CF₂═CF(CF₂)₂SO₂F,
CF₂═CFO[CF₂CF(CF₃)O]₂CF₂CF₂SO₂F, and
CF₂═CFOCF₂CF(CF₂OCF₃) OCF₂CF₂SO₂F.

Among these, CF₂═CFOCF₂CF(CF₃)OCF₂CF₂CF₂SO₂F and CF₂═CFOCF₂CF(CF₃)OCF₂CF₂SO₂F are preferable.

The monomers of the second group may be used singly or in combinations of two or more.

The variety of combinations of monomers constituting the polymer A, and their ratio, degree of polymerization, and the like are not particularly limited. The polymer A contained in the layer A may be a single polymer or a combination of two or more. The ion exchange capacity of the fluorine-containing polymer A having a sulfonic acid group can be adjusted by changing the ratio of monomers represented by the above general formulae (1) and (2).

The layer A may be a single layer, or may be composed of two or more layers, according to the composition of the constituting polymer A.

When the layer A is a single layer, the thickness thereof is preferably 50 μm or more and 180 μm or less, and more preferably 80 μm or more and 160 μm or less. When the thickness of the layer A is within the above range, the strength of the membrane body tends to be more increased.

In the present specification, when the layer A has a two-layer structure, the layer on the side that is brought into contact with the anode is a layer A-1, and the layer on the side that is brought into contact with the layer B is a fluorine-containing polymer layer A-2. Here, it is preferable that the fluorine-containing polymer that forms the layer A-1 (also referred to as a “fluorine-containing polymer A-1”) and the fluorine-containing polymer that forms the layer A-2 (also referred to as a “fluorine-containing polymer A-2”) have different compositions. The thickness of the layer A-1 is preferably 10 μm or more and 60 μm or less. The thickness of the layer A-2 is preferably 30 μm or more and 120 μm or less, and more preferably 40 μm or more and 100 μm or less. When the thicknesses of the layer A-1 and the layer A-2 are within the above ranges, the strength of the membrane body can be sufficiently maintained. The total thickness of the layer A-1 and the layer A-2 is preferably 50 μm or more and 180 μm or less, and more preferably 80 μm or more and 160 μm or less. When the layer A is composed of two or more layers, the layer A may be formed by laminating two or more films that are composed of polymers A having different compositions. As mentioned above, the thickness of the layer A is preferably 50 μm or more and 180 μm or less.

The ion exchange membrane in the present embodiment can be obtained via a hydrolysis step, as mentioned below. That is to say, taking the vinyl compound represented by the formula (2a) mentioned above as an example, the vinyl compound, after subjected to hydrolysis, will be contained in the layer A of the present embodiment as a polymer of a compound represented by the following formula (2b):

CF₂═CF—(OCF₂CYF)ₐ—O—(CF₂)_{b}—SO₂M (2b)

wherein a represents an integer of 0 to 2, b represents an integer of 1 to 4, Y represents —F or —CF₃, and M represents an alkali metal.

### [Layer B]

The layer B contained in the ion exchange membrane of the present embodiment contains a fluorine-containing polymer B having a carboxylic acid group (hereinafter sometimes simply referred to as a “polymer B”). Here, “the fluorine-containing polymer having a carboxylic acid group” refers to a fluorine-containing polymer having a carboxylic acid group or a carboxylic acid group precursor that can become a carboxylic acid group by hydrolysis. The layer B may contain a component other than the polymer B in a range of less than 10% by mass based on 100% by mass of the layer B, preferably contains the polymer B in an amount of 90% by mass or more based on 100% by mass of the layer B, and particularly preferably contains the polymer B in an amount of 100% by mass. Examples of the component that may be contained in the layer B other than the polymer B include, but are not limited to, metal chlorides such as potassium chloride.

The fluorine-containing polymer having a carboxylic acid group, which constitutes the layer B, can be produced by, for example, copolymerizing a monomer of the above first group and a monomer of a third group below, or homopolymerizing a monomer of the third group. In the case of being a copolymer, the polymer B may be a block copolymer or may be a random polymer.

The monomer of the third group is not particularly limited and is, for example, a vinyl compound having a functional group that can be converted into a carboxylic acid-type ion exchange group.

The vinyl compound having a functional group that can be converted into a carboxylic acid-type ion exchange group is preferably a compound represented by the following general formula (3a):

CF₂═CF—- (OCF₂CYF)_{c}—O—(CF₂)_{d}—COOR (3a)

wherein c represents an integer of 0 to 2, d represents an integer of 1 to 4, Y represents —F or —CF₃, and R represents —CH₃, —C₂H₅, or —C₃H₇.

In general formula (3a), when c is 2, a plurality of Y are mutually independent. In the above general formula (3a), it is preferable that Y is —CF₃, and R is —CH₃.

In particular, when the ion exchange membrane of the present embodiment is used as an ion exchange membrane for alkali electrolysis, it is preferable to use at least a perfluoro monomer as a monomer of the third group. Note that the alkyl group (see R above) in the ester group is lost from the polymer upon hydrolysis, and thus the alkyl group (R) does not need to be a perfluoroalkyl group. Among these, while the monomer of the third group is not particularly limited, for example, monomers shown below are more preferable:
CF₂═CFOCF₂CF(CF₃)OCF₂COOCH₃,
CF₂═CFOCF₂CF(CF₃)O(CF₂)₂COOCH₃,
CF₂═CF[OCF₂CF(CF₃)]₂O(CF₂)₂COOCH₃,
CF₂═CFOCF₂CF(CF₃)O(CF₂)₃COOCH₃,
CF₂═CFO(CF₂)₂COOCH₃, and
CF₂═CFO(CF₂)₃ COOCH₃.

In the present embodiment, the thickness of the layer B is 5 μm or more and 30 μm or less, preferably 10 μm or more and 30 μm or less, and more preferably 10 μm or more and 18 μm or less. When the thickness of the layer B is within this range, the electrolytic characteristics and gas zone damage resistance of the ion exchange membrane are further improved.

The ion exchange membrane in the present embodiment can be obtained via a hydrolysis step, as mentioned below. That is to say, taking the vinyl compound represented by the formula (3a) mentioned above as an example, the vinyl compound, after subjected to hydrolysis, will be contained in the layer A of the present embodiment as a polymer of a compound represented by the following formula (3b):

CF₂═CF—(OCF₂CYF)_{c}—O—(CF₂)_{d}—COOM (3b)

wherein c represents an integer of 0 to 2, d represents an integer of 1 to 4, Y represents —F or —CF₃, R represents —CH₃, —C₂H₅, or —C₃H₇, and M represents an alkali metal.

In the ion exchange membrane of the present embodiment, from the viewpoint of further improving electrolytic characteristics and strength, it is preferable that a polymer of a compound represented by the above formula (2a) be used as the raw material of the layer A and a polymer of a compound represented by the above formula (3a) be used as the raw material of the layer B. That is to say, it is preferred that the layer A comprise a polymer of a compound represented by the following formula (2b) and the layer B comprise a polymer of a compound represented by the following formula (3b):

CF₂═CF—(OCF₂CYF)ₐ—O—(CF₂)_{b}—SO₂M (2b)

wherein a represents an integer of 0 to 2, b represents an integer of 1 to 4, Y represents —F or —CF₃, and M represents an alkali metal;

CF₂═CF—(OCF₂CYF)_{c}—O—(CF₂)_{d}—COOM (3b)

wherein c represents an integer of 0 to 2, d represents an integer of 1 to 4, Y represents —F or —CF₃, R represents —CH₃, —C₂H₅, or —C₃H₇, and M represents an alkali metal.

In the ion exchange membrane of the present embodiment, the sum of the thickness of the layer A and the thickness of the layer B is preferably 55 μm or more, more preferably 55 μm or more and 210 μm or less, and even more preferably 90 μm or more and 185 μm or less. When the total thickness of the layer A and the layer B is within the range, there is a tendency that the electrolytic characteristics and damage resistance of the membrane's upper portion in the vicinity of the gasket are more improved. Here, the thicknesses of the layer A and the layer B mean the thicknesses of the layer A and the layer B constituting the ion exchange membrane subjected to a hydrolysis step, which will be described below, and can be measured by the method described in Examples. The thicknesses can be controlled by, for example, adjusting the extruder capacity and the rate of film take-up in a film forming step, which will be described below.

### [Ion Cluster Diameter]

In the ion exchange membrane of the present embodiment, the ion cluster diameter of the layer B is 1.8 to 2.48 nm, preferably 1.80 to 2.48 nm, more preferably 1.80 to 2.45 nm, even more preferably 1.80 to 2.45 nm, still more preferably 1.9 to 2.20 nm, further preferably 1.90 to 2.20, and even further preferably 1.90 to 2.10 nm. When the ion cluster diameter of the layer B within the above range, there is a tendency that the electrolytic characteristics and gas zone damage resistance of the ion exchange membrane are more improved. That is to say, when the ion cluster diameter of the layer B is 1.80 nm or more, an increase of voltage can be effectively suppressed, and a reduction in the gas zone damage resistance can be suppressed without breaking ion clusters in the layer B under electrolysis. When the ion cluster diameter is 2.48 nm or less, there is a tendency that the gas zone damage resistance is improved. The ion cluster diameters are measured by small angle X-ray scattering (SAXS) after peeling the layer A and the layer B into single-layer membranes consisting solely of the respective layers and impregnating the resulting film of the layer B with water at 25° C. When the ion exchange membrane has coating layers, SAXS measurement can be performed in the same manner as above except that the coating layers are removed with a brush and the like, and then the ion exchange membrane is separated into single-layer membranes consisting solely of the respective layers. Details will be described in Examples below.

The ion cluster diameter of the layer B can be adjusted within the range described above by, for example, adjusting the ion exchange capacity of the layer B and various conditions in the hydrolysis step in the method for producing an ion exchange membrane, which are mentioned below.

### [Ion Exchange Capacity]

In the present embodiment, “the ion exchange capacity of the layer A” means the ion exchange capacity of the fluorine-containing polymer constituting the layer A, and “the ion exchange capacity of the layer B” means the ion exchange capacity of the fluorine-containing polymer constituting the layer B. These ion exchange capacities are a factor that controls the ion cluster diameter. The ion exchange capacity of a fluorine-containing polymer refers to the equivalent of an exchange group per gram of dried resin and can be measured by neutralization titration. The ion exchange capacity of the fluorine-containing polymer B constituting the layer B in the present embodiment is not particularly limited, but is preferably 0.76 to 1.30 mEq/g, more preferably 0.81 to 1.20 mEq/g, from the viewpoint of reducing damage on the membrane's upper portion in the vicinity of the gasket. When the ion exchange capacity of the layer B (polymer B) is within the above range, the electrolytic characteristics and gas zone damage of the ion exchange membrane can be suppressed. That is to say, when the ion exchange capacity is 0.76 mEq/g or more, an increase in the electrolytic voltage can be suppressed. When the ion exchange capacity is 1.30 mEq/g or less, there is a tendency that the gas zone damage resistance is enhanced. There is a tendency that the larger the ion exchange capacity of each layer is, the larger the ion cluster diameter of the layer is, and the smaller the ion exchange capacity is, the smaller the ion cluster diameter is. The ion exchange capacity of each layer can be controlled by, for example, selection of a monomer that constitutes the fluorine-containing polymer contained in the layer and the content of the monomer. Specifically, for example, it can be controlled by the ratios of monomers of the above general formulae (1) to (3) introduced, and, more specifically, there is a tendency that the larger the contents of monomers containing ion exchange groups, which are represented by general formulae (2) and (3), are, the larger the ion exchange capacities are.

### [Reinforcement Core Material]

The ion exchange membrane of the present embodiment preferably contains the reinforcement core materials 3 within the membrane. It is preferable that the reinforcement core material is capable of reinforcing the strength and dimensional stability of the ion exchange membrane and is present inside the membrane body. The reinforcement core material is preferably a woven fabric or the like obtained by weaving a reinforcement yarn. The component of the reinforcement core material is preferably a fiber consisting of a fluorine polymer, from the viewpoint of imparting long-term heat resistance and chemical resistance. The component of the reinforcement core material is not particularly limited, and examples thereof include polytetrafluoroethylene (PTFE), a tetrafluoroethylene-perfluoroalkyl vinyl ether copolymer (PFA), a tetrafluoroethylene-ethylene copolymer (ETFE), a tetrafluoroethylene-hexafluoropropylene copolymer, a trifluorochlorethylene-ethylene copolymer, and a vinylidene fluoride polymer (PVDF). In particular, a fiber consisting of polytetrafluoroethylene is preferably used.

The yarn diameter of the reinforcement core material is preferably 20 to 300 deniers and more preferably 50 to 250 deniers, and the weaving density (the fabric count per unit length) is preferably 5 to 50 counts/inch. The form of the reinforcement core material is woven fabric, non-woven fabric, a knitted fabric, or the like, and the woven fabric form is preferable. The thickness of the woven fabric is preferably 30 to 250 μm, and more preferably 30 to 150 μm.

Neither the woven fabric nor the knitted fabric is particularly limited, and, for example, a monofilament, a multifilament, or a yarn or slit yarn thereof is used, and as for the weaving method, various weaving methods such as plain weave, leno weave, knitted weave, cord weave, and seersucker are used.

The aperture ratio of the reinforcement core material is not particularly limited, and is preferably 30% or more, and more preferably 50% or more and 90% or less. The aperture ratio is preferably 30% or more from the viewpoint of the electrochemical properties of the ion exchange membrane, and 90% or less from the viewpoint of the mechanical strength of the membrane. The aperture ratio is the ratio of the total area (B) where a substance such as an ion can pass in the ion exchange membrane to the total surface area (A) of the ion exchange membrane, and is expressed as (B)/(A). (B) is the total area of regions in the ion exchange membrane where ions, an electrolyte solution, and the like are not blocked by the reinforcement core material, the reinforcement yarn, and the like contained in the ion exchange membrane. The method for measuring the aperture ratio is as follows. A surface image of the ion exchange membrane (a cation exchange membrane before a coating and the like are applied) is captured, and (B) is determined from the area of parts where the reinforcement core material is not present. Then, (A) is determined from the area of the surface image of the ion exchange membrane, and the aperture ratio is determined by dividing (B) by (A).

As a particularly preferable form among these various reinforcement core materials, for example, it is preferable that 50 to 300 deniers of a tape yarn obtained by slitting a high-strength porous PTFE sheet into a tape form or a highly oriented PTFE monofilament is used, a plain weave configuration with a weaving density of 10 to 50 counts/inch is adopted, furthermore, the thickness is in the range of 50 to 100 μm, and the aperture ratio is 60% or more.

Furthermore, in the membrane production step, an auxiliary fiber, which is normally called a sacrifice core material, may be contained in the woven fabric to prevent yarn slippage of the reinforcement core material. Due to the sacrifice core material being contained, the continuous holes 2a, 2b can be formed in the ion exchange membrane.

The sacrifice core material dissolves in the membrane production step or the electrolysis environment and is not particularly limited, and rayon, polyethylene terephthalate (PET), cellulose, polyamide, and the like are used. The amount of the sacrifice core material contained in this case is preferably 10 to 80% by mass, and more preferably 30 to 70% by mass, of the entire woven fabric or knitted fabric.
[Continuous Holes]

The ion exchange membrane of the present embodiment may have the continuous holes 2a, 2b within the membrane. In the present embodiment, the continuous hole refers to a hole that can be a flow channel for cations produced during electrolysis and for an electrolyte solution. Due to the continuous holes formed, there is a tendency that the mobility of alkali ions produced during electrolysis and an electrolyte solution is more improved. The shape of the continuous holes is not particularly limited, and, according to the production method described below, can have the shape of a sacrifice core material used in the formation of continuous holes.

In the present embodiment, it is preferable that the continuous holes pass through the anode side (the layer A side) and the cathode side (the layer B side) of the reinforcement core material in an alternate manner. Due to such a structure, in a part where a continuous hole is formed on the cathode side of the reinforcement core material, cations (such as sodium ions) transported through the electrolyte solution with which the continuous hole is filled can flow into the cathode side of the reinforcement core material. As a result, the flow of cations is not blocked, and thus there is a tendency that the electrical resistance of the ion exchange membrane can be further reduced.

### [Coating]

As necessary, the ion exchange membrane of the present embodiment may have the coating layers 6, 7 on the cathode side and the anode side, respectively, for preventing attachment of gas. The material constituting the coating layers is not particularly limited, and from the viewpoint of preventing attachment of gas, it is preferable that an inorganic substance is contained. The inorganic substance is not particularly limited, and examples thereof include zirconium oxide and titanium oxide. The method for forming the coating layers is not particularly limited, and a known method can be used. An example is a method involving applying, with a spray or the like, a fluid containing fine particles of an inorganic oxide dispersed in a binder polymer solution.

### [Method for Producing Ion Exchange Membrane]

The ion exchange membrane according to the present embodiment is produced such that the ion cluster diameter of each of layers of the layer B containing a fluorine-containing polymer having a carboxylic acid group is controlled to a predetermined range, and accordingly, the ion exchange capacity, hydrolysis conditions, and the like of the fluorine-containing polymer B are preferably adjusted. Below, the method for producing the ion exchange membrane of the present embodiment will now be described in detail.

The method for producing the ion exchange membrane of the present embodiment is not particularly limited, and preferable is a production method including:

1) a step of producing fluorine-containing polymers having ion exchange groups or ion exchange group precursors that can become ion exchange groups by hydrolysis (a polymer production step);

2) a step of obtaining a reinforcement core material woven with a sacrifice yarn (a reinforcement core material production step);

3) a step of forming the fluorine-containing polymers having ion exchange groups or ion exchange group precursors that can become ion exchange groups by hydrolysis, into a film (a film formation step);

4) a step of forming a composite membrane by embedding the reinforcement core material and the film (an embedding step); and

5) a step of hydrolyzing the composite membrane with an acid or an alkali (a hydrolysis step).

Here, the “ion exchange group” refers to a sulfonic acid group or a carboxylic acid group.

As for the ion exchange membrane of the present embodiment, the ion cluster diameters can be adjusted by, for example, controlling the ion exchange capacities of the fluorine-containing polymers in the polymer production step 1) and/or controlling the hydrolysis conditions in the hydrolysis step 5) among the above steps. Hereinafter, each step will now be described.
Step 1) (Polymer Production Step)

The fluorine-containing polymer A having a sulfonic acid group, which constitutes the layer A, can be produced by, for example, copolymerizing a monomer of the first group and a monomer of the second group or homopolymerizing a monomer of the second group, as described above. The fluorine-containing polymer B having a carboxylic acid group, which constitutes the layer B, can be produced by, for example, copolymerizing a monomer of the first group and a monomer of the third group or homopolymerizing a monomer of the third group, as described above. The polymerization method is not particularly limited, and, for example, a polymerization method commonly used for polymerizing fluoroethylene, in particular tetrafluoroethylene, can be used.

The fluorine-containing polymers can be obtained by, for example, a non-aqueous method. In the non-aqueous method, a polymerization reaction can be performed, for example, using an inert solvent such as a perfluorohydrocarbon or chlorofluorocarbon in the presence of a radical polymerization initiator such as a perfluorocarbon peroxide or an azo compound under conditions having a temperature of 0 to 200° C. and a pressure of 0.1 to 20 MPa.

In the production of the fluorine-containing polymers, the variety of the combination of the above monomers and the proportions thereof are not particularly limited, and may be determined according to the kind, the amount, and the like of a functional group that is desired to be imparted to the resulting fluorine-containing polymers.

In the present embodiment, in order to control the ion exchange capacities of the fluorine-containing polymers, the ratio of the starting-material monomers mixed may be adjusted in the production of the fluorine-containing polymers that form the respective layers.

The fluorine-containing polymer A having a sulfonic acid group, which constitutes the layer A, is preferably produced by, for example, polymerizing a monomer represented by the above general formula (2a) or copolymerizing a monomer represented by the above general formula (1) and a monomer represented by the above general formula (2a) in the following molar ratio.

Monomer represented by the above general formula (1) : Monomer represented by the above general formula (2a)=4:1 to 7 1

The fluorine-containing polymer B having a carboxylic acid group, which constitutes the layer B, is preferably produced by, for example, polymerizing a monomer represented by the above general formula (3a) or copolymerizing a monomer represented by the above general formula (1) and a monomer represented by the above general formula (3a) in the following molar ratio.

Monomer represented by the above general formula (1) : Monomer represented by the above general formula (3a)=6:1 to 9:1
Step 2) (Reinforcement Core Material Production Step)

From the viewpoint of further improving membrane strength, a reinforcement core material is preferably embedded in the ion exchange membrane of the present embodiment. In the case of an ion exchange membrane having continuous holes, a sacrifice yarn is also woven into the reinforcement core material. The amount of the sacrifice yarn contained in this case is preferably 10 to 80% by mass and more preferably 30 to 70% by mass of the entire reinforcement core material. It is also preferable that the sacrifice yarn is a monofilament or a multifilament having a thickness of 20 to 50 deniers and consisting of polyvinyl alcohol or the like.
Step 3) (Film Formation Step)

The method for forming the fluorine-containing polymers obtained in step 1) into films is not particularly limited, and it is preferable to use an extruder. Examples of the film forming method are as follows.

When the layer A and the layer B constitute respective single layers, an example is a method involving separately forming the fluorine-containing polymer A and the fluorine-containing polymer B into films.

When the layer A has a two-layer structure consisting of layer A-1 and layer A-2, examples include a method involving forming the fluorine-containing polymer A2 and the fluorine-containing polymer B into a composite film by coextrusion, and, separately, forming the fluorine-containing polymer A-1 into a film independently; and a method involving forming the fluorine-containing polymer A-1 and the fluorine-containing polymer A-2 into a composite film by coextrusion, and, separately, forming the fluorine-containing polymer B into a film independently. Among these, coextrusion of the fluorine-containing polymer A-2 and the fluorine-containing polymer B contributes to increasing interfacial adhesive strength, and is thus preferable.
Step 4) (Embedding Step)

In the embedding step, it is preferable that the reinforcement core material obtained in step 2) and the films obtained in step 3) are embedded on a heated drum. On the drum, the reinforcement core material and the films are integrated into a single body by being embedded via a gas permeable, heat resistant release paper while removing air between the layers by reduced pressure under a temperature at which the fluorine-containing polymers constituting the respective layers melt, and thus a composite film is obtained. The drum is not particularly limited, and, for example, is a drum that has a heat source and a vacuum source, and the surface of which has a large number of micropores.

As for the order of laminating the reinforcement core material and the films, examples thereof include the following methods depending on step 3).

When the layer A and the layer B constitute respective single layers, an example is a method involving laminating a release paper, the layer A film, the reinforcement core material, and the layer B film on the drum in this order.

When the layer A has a two-layer structure consisting of the layer A-1 and the layer A-2, an example is a method involving laminating a release paper, the layer A film, the reinforcement core material, and a composite film of the layer A2 and the layer B film on the drum in this order; or a method involving laminating a release paper, a composite film of the layer A-1 and the layer A-2, the reinforcement core material, and the layer B on the drum in this order.

In order to provide projections on the membrane surface of the ion exchange membrane of the present embodiment, the use of a release paper that has been embossed in advance makes it possible to form projections consisting of molten polymers during embedding.
Step 5) (Hydrolysis Step)

The composite membrane obtained in step 4) is hydrolyzed with an acid or an alkali. In this hydrolysis step, the ion cluster diameters of the layer B can be controlled by changing hydrolysis conditions such as solution composition, hydrolysis temperature, and time. In the production of the ion exchange membrane according to the present embodiment, it is preferable to perform hydrolysis, for example, at 40 to 60° C. for 5 minutes to 24 hours in an aqueous solution of 2.5 to 4.0 N potassium hydroxide (KOH) and 20 to 40% by mass of dimethyl sulfoxide (DMSO). Thereafter, a salt exchange treatment is performed under 80 to 95° C. conditions using a 0.5 to 0.7 N caustic soda (NaOH) solution. The treatment time of the above salt exchange treatment is preferably less than two hours, from the viewpoint of preventing an increase in the electrolytic voltage. Furthermore, after the salt exchange treatment, the membrane is preferably immersed in a 1.0 to 5.0 N NaOH solution under 40 to 60° C. conditions for 10 to 60 minutes, in order to shrink the ion cluster diameter of the layer B down to 1.8 to 2.48 nm.

The ion cluster diameter can be controlled by changing the composition of the fluid on which hydrolysis treatment is performed, temperature, time, and the like. For example, a large ion cluster diameter can be achieved by lowering the KOH concentration, increasing the DMSO concentration, increasing the hydrolysis temperature, or extending the hydrolysis time. Coating layers may be provided on the surface of the hydrolyzed membrane.
[Electrolyzer]

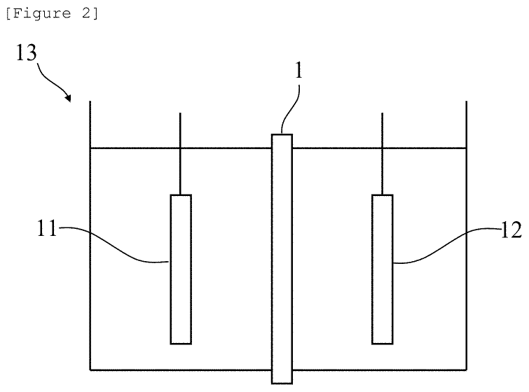

The electrolyzer of the present embodiment includes the ion exchange membrane of the present embodiment. FIG. 2 shows a schematic view of one example of the electrolyzer of the present embodiment. The electrolyzer 13 includes at least an anode 11, a cathode 12, and the ion exchange membrane 1 of the present embodiment disposed between the anode and the cathode. While the electrolyzer is usable in various types of electrolysis, a case where it is used in the electrolysis of an aqueous alkali chloride solution will now be described below as a representative example.

The electrolytic conditions are not particularly limited, and electrolysis can be performed under known conditions. For example, a 2.5 to 5.5 N aqueous alkali chloride solution is supplied to the anode chamber, water or a diluted aqueous alkali hydroxide solution is supplied to the cathode chamber, and electrolysis can be performed under conditions having an electrolysis temperature of 50 to 120° C. and a current density of 0.5 to 10 kA/m².

The configuration of the electrolyzer of the present embodiment is not particularly limited, and may be, for example, unipolar or bipolar. Materials constituting the electrolyzer are not particularly limited, and, for example, the material of the anode chamber is preferably titanium or the like that is resistant to alkali chloride and chlorine, and the material of the cathode chamber is preferably nickel or the like that is resistant to alkali hydroxide and hydrogen. As for the arrangement of electrodes, the ion exchange membrane and the anode may be disposed with a suitable space provided therebetween, or the anode and the ion exchange membrane may be disposed to be in contact. While the cathode is generally disposed so as to have a suitable space from the ion exchange membrane, a contact-type electrolyzer that does not have this space (a zero gap base electrolyzer) may be adopted.

### EXAMPLES

Below, the present embodiment will now be described in detail by way of Examples. The present embodiment is not limited to the following Examples.

The measurement methods in Examples and Comparative Examples are as follows.
[Method for Measuring Ion Cluster Diameter]

The ion cluster diameter was measured by small angle X-ray scattering (SAXS). As for SAXS measurement, when the ion exchange membrane had coating layers, the coating layers were removed with a brush, then the layer A and the layer B were peeled off, and single-layer membranes each composed solely of either layer were impregnated with water and measured at 25° C. In SAXS measurement, a SAXS apparatus Nano Viewer manufactured by Rigaku Corporation was used. Measurement was performed using a PILATUS 100K as a detector at a sample-detector distance of 841 mm for a small-angle area and the detector with an imaging plate at a sample-detector distance of 75 mm for a wide-angle area, and both profiles were combined to obtain scattering data at a scattering angle in the range of 0.1°<scattering angle (2θ)<30°. Measurement was performed with 7 samples being placed one on top of the other, and the exposure time was 15 minutes for both small-angle area and wide-angle area measurements. When data was acquired with a two-dimensional detector, data was made one-dimensional by a reasonable process such as circular averaging. Corrections derived from the detector such as dark current corrections of the detector and corrections on scattering due to substances other than the sample (empty cell scattering corrections) were made on the obtained SAXS profile. When the influence of the X-ray beam shape (the influence of smear) on the SAXS profile was large, corrections (desmear) were also made on the X-ray beam shape. As for the one-dimensional SAXS profile obtained in this way, the ion cluster diameter was determined in accordance with the technique described by Yasuhiro Hashimoto, Naoki Sakamoto, Hideki Iijima, Kobunshi Ronbunshu (Japanese Journal of Polymer Science and Technology) vol. 63, No. 3, p.166, 2006. That is to say, assuming that the ion cluster structure was represented by a core-shell type hard sphere having a particle size distribution, and using a theoretical scattering formula that is based on this model, fitting was performed in reference to the SAXS profile of a scattering angle region where scattering derived from ion clusters is dominant in the actually measured SAXS profile, to thereby determine the average cluster diameter (the ion cluster diameter) and the ion cluster number density. In this model, the core part was regarded as corresponding to the ion cluster, and the core diameter as the ion cluster diameter. The shell layer was imaginary, and the electron density of the shell layer was regarded as being the same as that of the matrix part. Also, the shell layer thickness here was 0.25 nm. The theoretical scattering formula of the model used for fitting is presented below as formula (A). Also, the fitting range was 1.4<2θ<6.7°.

$$\begin{matrix}{I}_{HS} ( q ) = CNS ( q , {a}_{2} , η ) {\int }_{0}^{∞} {P ( a ) [ V ( a ) Φ ( qa ) ]}^{2} da + {I}_{b} ( q ) & formula ( A ) \\ wherein & \\ q = 4 π sin θ / λ & \\ S ( q , {a}_{2} , η ) = \frac{1}{1 + 24 η [ G ( A ) / A ]} & \\ G ( A ) = \frac{α}{{A}^{2}} ( sin A - A cos A ) + \frac{β}{{A}^{3}} [ 2 A sin A + ( 2 - {A}^{2} ) cos A - 2 ] + \frac{γ}{{A}^{5}} ( - {A}^{4} cos A + 4 [ ( 3 {A}^{2} - 6 ) cos A + ( {A}^{3} - 6 A ) sin A + 6 ] ) & \\ α = {( 1 + 2 η )}^{2} / {( 1 - η )}^{4} & \\ β = - 6 {η ( 1 + η / 2 )}^{2} / {( 1 - η )}^{4} & \\ γ = 1 / 2 {η ( 1 + 2 η )}^{2} / {( 1 - η )}^{4} & \\ A = 2 {qa}_{2} & \\ {a}_{2} = {a}_{0} + 1 & \\ V ( a ) = \frac{4}{3} π {a}^{3} & \\ Φ ( qa ) = \frac{3}{{( qa )}^{3}} [ sin ( qa ) - ( qa ) cos ( qa ) ] & \\ P ( a ) = \frac{p ( a ) / V ( a )}{\int p ( a ) / V ( a ) da} & \\ p ( a ) = \frac{{M}^{M}}{Γ ( M ) {a}_{0}^{M}} {a}^{M - 1} exp ( - \frac{M}{{a}_{0}} a ) & \\ M = {( \frac{σ}{{a}_{0}} )}^{- 2} & \end{matrix}$$

Above, C represents a constant; N represents a cluster number density; η represents the volume fraction of a hard sphere, assuming that the core, i.e., the ion cluster part, and the surrounding imaginary shell constitute a hard sphere; θ represents a Bragg angle; λ represents an X ray wavelength used; t represents a shell layer thickness; a₀ represents an average ion cluster radius, Γ(x) represents a gamma function; and σ represents the standard deviation of the ion cluster radius (the core radius). P(a) represents the distribution function of core radius a, where the volume distribution of a follows Schultz-Zimm distribution p(a). M is a parameter representing distribution. Ib(q) represents background scattering including scattering derived from excessive water during measurement and thermal diffuse scattering, and is assumed as a constant here. Among the parameters above, N, η, a₀, σ, and Ib(q) are variable parameters in fitting. In this specification, the ion cluster diameter means the average diameter of ion clusters (2aₒ).
[Method for Measuring Thickness of Each Layer After Hydrolysis Step]

The ion exchange membrane after the hydrolysis step was cut at a width of about 100 μm in the cross-sectional direction from the layer A-1 side or the layer B side, and the thickness was actually measured in a hydrated state using an optical microscope, with the cross section facing upward. At this time, the part that was cut was an intermediate part (a valley part) between adjacent reinforcement core materials, the portion measured on the obtained cross-sectional view, in reference to FIG. 1, is an intermediate part between adjacent reinforcement core materials 3, and the thicknesses of the layer A and the layer B were measured, with the direction from (a) toward (β) being regarded as the thickness direction.
[Electrolytic Characteristics Evaluation]

Electrolysis was performed under the following conditions using the electrolyzer shown in FIG. 2, and electrolytic characteristics were evaluated based on the electrolytic voltage and current efficiency.

Brine was supplied to the anode side while adjusting the sodium chloride concentration to be 3.5 N, and water was supplied while maintaining the caustic soda concentration on the cathode side at 10.8 N. The temperature of brine was set to 85° C., and electrolysis was performed under conditions where the current density was 6 kA/m², and the fluid pressure on the cathode side of the electrolyzer was 5.3 kPa higher than the fluid pressure on the anode side.

The interelectrode voltage between the anode and the cathode of the electrolyzer was measured everyday using TR-V1000, a voltmeter manufactured by KEYENCE CORPORATION, and the average value for 7 days was determined as the electrolytic voltage.
[Test On Damage On the Membrane's Upper Portion in the Vicinity of the Gasket]

Electrolysis was performed under the following conditions using the electrolyzer shown in FIG. 2.

Brine was supplied to the anode side while adjusting the sodium chloride concentration to be 3.5 N, and water was supplied while maintaining the caustic soda concentration on the cathode side at 10.8 N. The temperature of brine was set to 90° C., and electrolysis was performed under conditions where the current density was 4 kA/m², and the fluid pressure on the cathode side of the electrolyzer was 5.3 kPa higher than the fluid pressure on the anode side. In the electrolytic cell, a portion of a nozzle, the length of which portion was 50 mm, was inserted in the electroconductive surface direction into the gas bent line in the upper portion on the anode side, and electrolysis was performed for 3 days in the state where chlorine gas accumulation was present above the electroconductive surface.

On a portion including the interface portion between the electroconductive surface and the non-electroconductive surface of the upper portion of the membrane after electrolysis, tensile elongation was measured in a −45 degree direction from a reinforcing fabric in accordance with JIS K 6251, and the average of five points in each example was taken as the evaluation value.

### Example 1

As a fluorine-containing polymer A-1, a monomer represented by the following general formula (1) (X₁═F, X₂═F) and a monomer represented by the following general formula (2a) (a=1, b=2, Y═CF₃) were copolymerized in a molar ratio of 5:1 to give a polymer having an ion exchange capacity of 1.05 mEq/g.

CF₂═CX₁X₂ (1)

wherein X₁ and X₂ each independently represent —F, —Cl , —H, or —CF₃.

CF₂═CF—(OCF₂CYF)ₐ—O—(CF₂)_{b}—SO₂F (2a)

wherein a represents an integer of 0 to 2, b represents an integer of 1 to 4, Y represents —F or —CF₃, where, when a is 2, a plurality of Y are mutually independent.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the following general formula (3a) (c=1, d=2, Y═CF₃, R═CH₃) were copolymerized in a molar ratio of 8.2:1 to give a polymer having an ion exchange capacity of 0.83 mEq/g.

CF₂○CF—(OCF₂CYF)_{c}—O—(CF₂)_{d}—COOR (3a)

wherein c represents an integer of 0 to 2, d represents an integer of 1 to 4, Y represents —F or —CF₃, where, when c is 2, a plurality of Y are mutually independent, and R represents —CH₃, —C₂H₅, or —C₃H₇.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A-2 was 80 μm, and the thickness of the layer B was 13 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. As for the reinforcement core material, a 100-denier polytetrafluoroethylene (PTFE) tape yarn twisted 900 times/m into a thread form as well as 30-denier, 6-filament polyethylene terephthalate (PET) twisted 200 times/m as a warp yarn and a 35-denier, 8-filament PET thread twisted 10 times/m as a weft yarn of auxiliary fiber (a sacrifice yarn) were provided, and these yarns were plain-woven in an alternate arrangement such that the PTFE yarn was 24 counts/inch and the sacrifice yarn was 4 times PTFE, i.e., 64 counts/inch, to give a woven fabric having a thickness of 100 μm. The resulting woven fabric was pressure-bonded with a heated metal roll to regulate the thickness of the woven fabric to 70 μm. At this time, the aperture ratio of the PTFE yarn alone was 75%.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.20 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 41%. These results are shown in Table 1.

### Example 2

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the general formula (1) (X₁═F, X₂═F) and a monomer represented by the general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 8.4:1 to give a polymer having an ion exchange capacity of 0.81 mEq/g.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A-2 was 80 μm, and the thickness of the layer B was 13 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.45 nm. [0093]

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 39%. These results are shown in Table 1.

### Example 3

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 8.8:1 to give a polymer having an ion exchange capacity of 0.78 mEq/g.

The resulting fluorine polymer A-2 and the fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A-2 was 80 μm, and the thickness of the layer B was 13 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 60° C. for 24 hours in an aqueous solution containing 30% by mass of DMSO and 4.0 N of KOH and then subjected to salt exchange treatment for 30 minutes under 70° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.00 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 43%. These results are shown in Table 1.

### Example 4

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 8.6:1 to give a polymer having an ion exchange capacity of 0.77 mEq/g.

The resulting fluorine polymer A-2 and the fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A2 was 80 μm, and the thickness of the layer B was 13 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 1.80 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 41%, the tensile elongation in a 45-degree upward direction from the ion exchange membrane after the above electrolysis evaluation was 35%. These results are shown in Table 1.

### Example 5

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y○CF₃, R═CH₃) were copolymerized in a molar ratio of 7.8:1 to give a polymer having an ion exchange capacity of 0.87 mEq/g.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A2 was 80 μm, and the thickness of the layer B was 13 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 47° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.47 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 30%. These results are shown in Table 1.

### Example 6

As a fluorine-containing polymer A-1, a monomer represented by the general formula (1) (X₁═F, X₂═F) and a monomer represented by the general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the general formula (1) (X₁═F, X₂═F) and a monomer represented by the general formula (2a) (a=1, b=2, Y═CF₃) were copolymerized in a molar ratio of 6:1 to give a polymer having an ion exchange capacity of 0.95 mEq/g.

As a fluorine-containing polymer B forming the layer B, a monomer represented by the general formula (1) (X₁═F, X₂═F) and a monomer represented by the general formula (3a) (c=1, d=2, Y═CF₃, R═CH₃) were copolymerized in a molar ratio of 8.6:1 to give a polymer having an ion exchange capacity of 0.77 mEq/g.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A2 was 80 μm, and the thickness of the layer B was 10 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 1.80 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 41%, the tensile elongation in a 45-degree upward direction from the ion exchange membrane after the above electrolysis evaluation was 32%. These results are shown in Table 1.

### Comparative Example 1

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 4:1 to give a polymer having an ion exchange capacity of 1.32 mEq/g.

The fluorine-containing polymer A-2 and fluorine-containing polymer B were provided and coextruded with an apparatus equipped with 2 extruders, a coextrusion T die for 2 layers, and a take-up machine, to give a two-layer film (a4) having a thickness of 93 μm. As a result of observing the cross section of the film under an optical microscope, the thickness of the layer A2 was 80 μm, and the thickness of the layer B was 13 μm. A single-layer film (b4) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b4), a reinforcement core material, and the two-layer film (a4) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 90° C. for 1 hour in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged membrane by a spray method and dried to thereby form coating layers.

The ion cluster diameter of the fluorine polymer layer B of this ion exchange membrane was 3.60 nm. [0138]

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 46%, the tensile elongation in a 45-degree upward direction from the ion exchange membrane after the above electrolysis evaluation was 8%. These results are shown in Table 1.

### Comparative Example 2

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 7.7:1 to give a polymer having an ion exchange capacity of 0.88 mEq/g.

The fluorine polymer A-2 and fluorine polymer B were coextruded with an apparatus equipped with 2 extruders, a coextrusion T die for 2 layers, and a take-up machine, to give a two-layer film (a5) having a thickness of 93 μm. As a result of observing the cross section of the film under an optical microscope, the thickness of the fluorine-containing layer A2 was 80 μm, and the thickness of the layer B was 13 μm. A single-layer film (b5) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b5), a reinforcement core material, and the two-layer film (a5) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 75° C. for 12 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 3.00 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 45%, the tensile elongation in a 45-degree upward direction from the ion exchange membrane after the above electrolysis evaluation was 9%. These results are shown in Table 1.

### Comparative Example 3

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 8.4:1 to give a polymer having an ion exchange capacity of 0.81 mEq/g.

The fluorine polymer A-2 and the fluorine polymer B were coextruded with an apparatus equipped with 2 extruders, a coextrusion T die for 2 layers, and a take-up machine, to give a two-layer film (a5) having a thickness of 93 μm. As a result of observing the cross section of the film under an optical microscope, the thickness of the fluorine-containing layer A2 was 80 μm, and the thickness of the layer B was 13 μm. A single-layer film (b5) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b5), a reinforcement core material, and the two-layer film (a5) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 60° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.50 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the electrolysis evaluation was 43%, the tensile elongation in a 45-degree upward direction from the ion exchange membrane after the above electrolysis evaluation was 20%. These results are shown in Table 1.

### Comparative Example 4

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 9:1 to give a polymer having an ion exchange capacity of 0.75 mEq/g. [0160]

The fluorine polymer A-2 and the fluorine polymer B were coextruded with an apparatus equipped with 2 extruders, a coextrusion T die for 2 layers, and a take-up machine, to give a two-layer film (a5) having a thickness of 93 μm. As a result of observing the cross section of the film under an optical microscope, the thickness of the fluorine-containing layer A2 was 80 μm, and the thickness of the layer B was 13 μm. A single-layer film (b5) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b5), a reinforcement core material, and the two-layer film (a5) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 70° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 1.70 nm.

The thicknesses of the layer A and the layer B of the ion exchange membrane obtained as above were measured in accordance with [Method for measuring thickness of each layer]. Then, electrolysis evaluation was performed on the ion exchange membrane obtained. The electrolytic voltage was significantly higher than that in Examples 1 to 4. Whereas the tensile elongation in a 45-degree upward direction from the ion exchange membrane before the above electrolysis evaluation was 42%, the tensile elongation in a 45-degree upward direction from the ion exchange membrane after the above electrolysis evaluation was 42%. These results are shown in Table 1.

### Comparative Example 5

As a fluorine-containing polymer A-1, a monomer represented by the above general formula (1) (X₁═F, X₂═F) and a monomer represented by the above general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the above general formula (1) (X₁═F, X₂═F) and a monomer represented by the above general formula (2a) (a=1, b=2, Y═CF₃) were copolymerized in a molar ratio of 6:1 to give a polymer having an ion exchange capacity of 0.95 mEq/g.

As a fluorine-containing polymer B for forming the layer B, a monomer represented by the above general formula (1) (X₁═F, X₂═F) and a monomer represented by the above general formula (3a) (c=1, d=2, Y═CF₃, R═CH₃) were copolymerized in a molar ratio of 7.8:1 to give a polymer having an ion exchange capacity of 0.87 mEq/g.

The resulting fluorine polymer A-2 and the fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A2 was 80 μm, and the thickness of the layer B was 13 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F, was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.60 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 15%. These results are shown in Table 1.

### Comparative Example 6

As a fluorine-containing polymer A-1, a monomer represented by the general formula (1) (X₁═F, X₂═F) and a monomer represented by the general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the general formula (1) (X₁═F, X₂═F) and a monomer represented by the general formula (2a) (a=1, b=2, Y═CF₃) were copolymerized in a molar ratio of 6:1 to give a polymer having an ion exchange capacity of 0.95 mEq/g.

As a fluorine-containing polymer B forming the layer B, a monomer represented by the general formula (1) (X₁═F, X₂═F) and a monomer represented by the general formula (3a) (c=1, d=2, Y═CF₃, R═CH₃) were copolymerized in a molar ratio of 8.4:1 to give a polymer having an ion exchange capacity of 0.81 mEq/g.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 84 μm. As a result of observing the cross section of the film under an optical microscope, the thickness of the layer A2 was 80 μm, and the thickness of the layer B was 4 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.45 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 9%. These results are shown in Table 1.

### Comparative Example 7

As a fluorine-containing polymer A-1, a monomer represented by the general formula (1) (X₁═F, X₂═F) and a monomer represented by the general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the general formula (1) (X₁═F, X₂═F) and a monomer represented by the general formula (2a) (a=1, b=2, Y═CF₃) were copolymerized in a molar ratio of 6:1 to give a polymer having an ion exchange capacity of 0.95 mEq/g.

As a fluorine-containing polymer B forming the layer B, a monomer represented by the general formula (1) (X₁═F, X₂═F) and a monomer represented by the general formula (3a) (c=1, d=2, Y═CF₃, R═CH₃) were copolymerized in a molar ratio of 8.4:1 to give a polymer having an ion exchange capacity of 0.81 mEq/g.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 111 μm. As a result of observing the cross section of the film under an optical microscope, the thickness of the layer A2 was 80 μm, and the thickness of the layer B was 31 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.44 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 41%. These results are shown in Table 1.

### Comparative Example 8

As a fluorine-containing polymer A-1, a monomer represented by the general formula (1) (X₁═F, X₂═F) and a monomer represented by the general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the general formula (1) (X₁═F, X₂═F) and a monomer represented by the general formula (2a) (a=1, b=2, Y═CF₃) were copolymerized in a molar ratio of 6:1 to give a polymer having an ion exchange capacity of 0.95 mEq/g.

As a fluorine-containing polymer B forming the layer B, a monomer represented by the general formula (1) (X1=F, X2=F) and a monomer represented by the general formula (3a) (c=1, d=2, Y═CF₃, R═CH₃) were copolymerized in a molar ratio of 8.4:1 to give a polymer having an ion exchange capacity of 0.81 mEq/g.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A2 was 80 μm, and the thickness of the layer B was 13 μm. A single-layer film (b2) having a thickness of 20 μm for the layer A-1 was obtained with a single-layer T die.

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 70° C. conditions in a 1.0 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)₃SO₂F was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.60 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 14%. These results are shown in Table 1.

### Comparative Example 9

As a fluorine-containing polymer A-1, a monomer represented by the general formula (1) (X₁═F, X₂═F) and a monomer represented by the general formula (2a) (a=1, b=2, Y═CF₃) were copolymerized in a molar ratio of 5:1 to give a polymer having an ion exchange capacity of 1.05 mEq/g.

As a fluorine-containing polymer A-2, a monomer represented by the general formula (1) (X₁═F, X₂═F) and a monomer represented by the general formula (2a) (a=1, b=2, Y═CF₃) were copolymerized in a molar ratio of 6:1 to give a polymer having an ion exchange capacity of 0.95 mEq/g.

As a fluorine-containing polymer B forming the layer B, a monomer represented by the general formula (1) (X₁═F, X₂═F) and a monomer represented by the general formula (3a) (c=1, d=2, Y═CF₃, R═CH₃) were copolymerized in a molar ratio of 8.4:1 to give a polymer having an ion exchange capacity of 0.81 mEq/g.

The resulting fluorine polymer A-2 and fluorine polymer B were coextruded with an apparatus equipped with 2 extruders, a coextrusion T die for 2 layers, and a take-up machine, to give a two-layer film (a2) having a thickness of 93 μm. As a result of observing the cross section of the film under an optical microscope, the thickness of the layer A2 was 80 μm, and the thickness of the layer B was 13 μm. A single-layer film (b2) having a thickness of 20 μm for the layer A-1 was

On a drum having a heat source and a vacuum source inside and having a large number of micropores in the surface, an air-permeable, heat-resistant release paper, the single-layer film (b2), a reinforcement core material, and the two-layer film (a2) were laminated in this order and integrated into a single body while eliminating air between the materials at a temperature of 230° C. under a reduced pressure of −650 mmHg to give a composite membrane. The same reinforcement core material as in Example 1 was used.

This composite membrane was hydrolyzed at a temperature of 50° C. for 24 hours in an aqueous solution containing 30% by mass of DMSO and 4.0 N of KOH and then subjected to salt exchange treatment for 30 minutes under 90° C. conditions using a 0.6 N NaOH solution. Thereafter, the membrane was immersed for 20 minutes under 50° C. conditions in a 0.5 N NaOH solution.

A fluorine polymer having a sulfonic acid group, which had an ion exchange capacity of 1.0 mEq/g and were obtained by hydrolyzing a copolymer of CF₂═CF₂ and CF₂═CFOCF₂CF(CF₃)O(CF₂)3SO₂F was dissolved in a 50/50 parts by mass mixed solution of water and ethanol in an amount of 20% by mass. Zirconium oxide having an average primary particle size of 1 μm was added to the solution in an amount of 40% by mass, and uniformly dispersed with a ball mill to give a suspension. This suspension was applied to both surfaces of the hydrolyzed, salt-exchanged ion exchange membrane by a spray method and dried to thereby form coating layers.

The ion cluster diameter of the layer B of this ion exchange membrane was 2.58 nm.

The thicknesses of the layer A and the layer B of the ion exchange membrane obtained as above were measured in accordance with [Method for measuring thickness of each layer]. Then, electrolysis evaluation was performed on the ion exchange membrane obtained. Whereas the tensile elongation in a 45-degree upward direction from the ion exchange membrane before the above electrolysis evaluation was 43%, the tensile elongation in a 45-degree upward direction from the ion exchange membrane after the above electrolysis evaluation was 16%. These results are shown in Table 1.

The compositions, properties, and the like of the ion exchange membranes produced in each Example and Comparative Example are shown in Table 1.

TABLE 1

| | | | | | | | | | Com- | Com- | Com- | Com- | Com- | Com- | Com- | Com- | Com- |
|---|---|---|---|---|---|---|---|---|---|---|---|---|---|---|---|---|---|
| | | | | | | | | | para- | para- | para- | para- | para- | para- | para- | para- | para- |
| | | | | | | | | | tive | tive | tive | tive | tive | tive | tive | tive | tive |
| | | | Ex- | Ex- | Ex- | Ex- | Ex- | Ex- | Ex- | Ex- | Ex- | Ex- | Ex- | Ex- | Ex- | Ex- | Ex- |
| | | | ample | ample | ample | ample | ample | ample | ample | ample | ample | ample | ample | ample | ample | ample | ample |
| | | Unit | 1 | 2 | 3 | 4 | 5 | 6 | 1 | 2 | 3 | 4 | 5 | 6 | 7 | 8 | 9 |
| Layer A-1 | Ion | mEq/g | 1.05 | 1.05 | 1.05 | 1.05 | 1.05 | 1.05 | 1.05 | 1.05 | 1.05 | 1.05 | 1.05 | 1.05 | 1.05 | 1.05 | 1.05 |
| (single- | exchange | | | | | | | | | | | | | | | | |
| layer | capacity | | | | | | | | | | | | | | | | |
| film (b)) | Thickness | μm | 20 | 20 | 20 | 20 | 20 | 20 | 20 | 20 | 20 | 20 | 20 | 20 | 20 | 20 | 20 |
| Layer A-2 | Ion | mEq/g | 0.95 | 0.95 | 0.95 | 0.95 | 0.95 | 0.95 | 0.95 | 0.95 | 0.95 | 0.95 | 0.95 | 0.95 | 0.95 | 0.95 | 0.95 |
| (composite | exchange | | | | | | | | | | | | | | | | |
| film(a)) | capacity | | | | | | | | | | | | | | | | |
| | Thickness | μm | 80 | 80 | 80 | 80 | 80 | 80 | 80 | 80 | 80 | 80 | 80 | 80 | 80 | 80 | 80 |
| Layer B | Ion | mEq/g | 0.83 | 0.81 | 0.78 | 0.77 | 0.87 | 0.77 | 1.32 | 0.88 | 0.81 | 0.75 | 0.87 | 0.81 | 0.81 | 0.81 | 0.81 |
| (composite | exchange | | | | | | | | | | | | | | | | |
| film(a)) | capacity | | | | | | | | | | | | | | | | |
| | Thickness | μm | 13 | 13 | 13 | 13 | 13 | 10 | 13 | 13 | 13 | 13 | 13 | 4 | 31 | 13 | 13 |
| Structure of | a | — | 1 | 1 | 1 | 1 | 1 | 1 | 1 | 1 | 1 | 1 | 1 | 1 | 1 | 1 | 1 |
| fluorine- | b | — | 2 | 2 | 2 | 2 | 2 | 2 | 2 | 2 | 2 | 2 | 2 | 2 | 2 | 2 | 2 |
| containing | c | — | 1 | 1 | 1 | 1 | 1 | 1 | 1 | 1 | 1 | 1 | 1 | 1 | 1 | 1 | 1 |
| polymer | d | — | 2 | 2 | 2 | 2 | 2 | 2 | 2 | 2 | 2 | 2 | 2 | 2 | 2 | 2 | 2 |
| represented by | X₁ | — | F | F | F | F | F | F | F | F | F | F | F | F | F | F | F |
| [formula (1), | X₂ | — | F | F | F | F | F | F | F | F | F | F | F | F | F | F | F |
| formula (2), | Y (in | — | CF₃ | CF₃ | CF₃ | CF₃ | CF₃ | CF₃ | CF₃ | CF₃ | CF₃ | CF₃ | CF₃ | CF₃ | CF₃ | CF₃ | CF₃ |
| formula (3)] | formula (2)) | | | | | | | | | | | | | | | | |
| | Y (in | — | CF₃ | CF₃ | CF₃ | CF₃ | CF₃ | CF₃ | CF₃ | CF₃ | CF₃ | CF₃ | CF₃ | CF₃ | CF₃ | CF₃ | CF₃ |
| | formula (3)) | | | | | | | | | | | | | | | | |
| | R | — | CH₃ | CH₃ | CH₃ | CH₃ | CH₃ | CH₃ | CH₃ | CH₃ | CH₃ | CH₃ | CH₃ | CH₃ | CH₃ | CH₃ | CH₃ |
| Hydrolysis | Temperature | ° C. | 50 | 50 | 60 | 50 | 47 | 50 | 90 | 75 | 60 | 50 | 50 | 50 | 50 | 50 | 50 |
| | Time | Hours | 24 | 24 | 24 | 24 | 24 | 24 | 1 | 12 | 24 | 24 | 24 | 24 | 24 | 24 | 24 |
| Salt exchange | Temperature | ° C. | 90 | 90 | 70 | 90 | 90 | 90 | 90 | 90 | 90 | 70 | 90 | 90 | 90 | 90 | 90 |
| | Time | Hours | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| NaOH | Temperature | ° C. | 50 | 50 | 50 | 50 | 50 | 50 | 50 | 50 | 50 | 50 | 50 | 50 | 50 | 70 | 50 |
| immersion | NaOH | N | 1.0 | 1.0 | 1.0 | 1.0 | 1.0 | 1.0 | 1.0 | 1.0 | 1.0 | 1.0 | 1.0 | 1.0 | 1.0 | 1.0 | 0.5 |
| | concen- | | | | | | | | | | | | | | | | |
| | tration | | | | | | | | | | | | | | | | |
| | Time | Minutes | 20 | 20 | 20 | 20 | 20 | 20 | 20 | 20 | 20 | 20 | 20 | 20 | 20 | 20 | 20 |
| Membrane | Layer B | μm | 13 | 13 | 13 | 13 | 13 | 10 | 13 | 13 | 13 | 13 | 13 | 4 | 31 | 13 | 13 |
| thickness | | | | | | | | | | | | | | | | | |
| (after | | | | | | | | | | | | | | | | | |
| hydrolysis | | | | | | | | | | | | | | | | | |
| step) | | | | | | | | | | | | | | | | | |
| Ion cluster | Ion cluster | nm | 2.20 | 2.45 | 2.00 | 1.80 | 2.47 | 1.80 | 3.60 | 3.00 | 2.50 | 1.70 | 2.60 | 2.45 | 2.44 | 2.60 | 2.58 |
| | diameter | | | | | | | | | | | | | | | | |
| | of layer | | | | | | | | | | | | | | | | |
| | B | | | | | | | | | | | | | | | | |
| Electrolytic | Voltage | V | 3.05 | 3.04 | 3.05 | 3.07 | 3.05 | 3.04 | 3.02 | 3.04 | 3.05 | 3.15 | 3.06 | 3.00 | 3.12 | 3.04 | 3.04 |
| characteristics | | | | | | | | | | | | | | | | | |

| | | | | | | | | | | | | | | | | |
|---|---|---|---|---|---|---|---|---|---|---|---|---|---|---|---|---|
| Tensile elongation of | % | 41 | 39 | 43 | 35 | 30 | 32 | 8 | 9 | 20 | 42 | 15 | 9 | 41 | 14 | 16 |
| membrane's upper portion | | | | | | | | | | | | | | | | |
| in the vicinity of | | | | | | | | | | | | | | | | |
| gasket (average of 5 | | | | | | | | | | | | | | | | |
| measurements) | | | | | | | | | | | | | | | | |

The ion exchange membranes of Examples 1 to 6 had excellent electrolytic characteristics and also had excellent gas zone damage resistance.

In contrast, the ion exchange membranes of Comparative Examples 1 to 3, and 5, 6, 8, and 9, with respect to electrolytic characteristics, had values at which the ion exchange membranes can sufficiently withstand electrolysis, but exhibited gas zone damage resistance inferior to that of the ion exchange membranes of Examples 1 to 6. The ion exchange membranes of Comparative Example 4 and 7, with respect to gas zone damage resistance, had values at which the ion exchange membranes can sufficiently withstand electrolysis, but resulted in electrolytic characteristics inferior to those of the ion exchange membranes of Examples 1 to 6.

The present application claims a priority from a Japanese Patent Application (Japanese Patent Application No. 2018-208426) filed on Nov. 5, 2018 and a Japanese Patent Application (Japanese Patent Application No. 2019-183671) filed on Oct. 4, 2019, the contents of which are hereby incorporated by reference.

### INDUSTRIAL APPLICABILITY

The ion exchange membrane of the present invention can be suitably used in the field of alkali chloride electrolysis.

### REFERENCE SIGNS LIST

1 Ion exchange membrane

2a Continuous hole

2b Continuous hole

3 Reinforcement core material

4 Layer A

5 Layer B

6 Coating layer

7 Coating layer

8 Portion appearing on anode-side surface of layer A

α Anode side of electrolytic layer

β Cathode side of electrolytic layer

11 Anode

12 Cathode

13 Electrolyzer

1. An ion exchange membrane comprising:
a layer A comprising a fluorine-containing polymer having a sulfonic acid group; and
a layer B comprising a fluorine-containing polymer having a carboxylic acid group, wherein
the layer B has a thickness of 5 to 30 μm, and
the layer B has an ion cluster diameter of 1.8 to 2.48 nm.

2. The ion exchange membrane according to claim 1, wherein the layer B has an ion exchange capacity of 0.76 to 1.30 mEq/g.

3. The ion exchange membrane according to claim 1, wherein
the layer A comprises a polymer of a compound represented by the following formula (2b); and
the layer B comprises a polymer of a compound represented by the following formula (3b):
CF₂═CF—(OCF₂CYF)ₐ—O—(CF₂)_{b}—SO₂M (2b)
wherein a represents an integer of 0 to 2, b represents an integer of 1 to 4, Y represents —F or —CF₃, and M represents an alkali metal; and
CF₂═CF—(OCF₂CYF)_{c}—O—(CF₂)_{d}—COOM (3b)
wherein c represents an integer of 0 to 2, d represents an integer of 1 to 4, Y represents —F or —CF₃, R represents —CH₃, —C₂H₅, or —C₃H_{7,} and M represents an alkali metal.

4. The ion exchange membrane according to claim 2, wherein
the layer A comprises a polymer of a compound represented by the following formula (2b); and
the layer B comprises a polymer of a compound represented by the following formula (3b):
CF₂═CF—(OCF₂CYF)ₐ—O—(CF₂)_{b}—SO₂M (2b)
wherein a represents an integer of 0 to 2, b represents an integer of 1 to 4, Y represents —F or —CF₃, and M represents an alkali metal; and
CF₂═CF—(OCF₂CYF)_{c}—O—(CF₂)_{d}—COOM (3b)
wherein c represents an integer of 0 to 2, d represents an integer of 1 to 4, Y represents —F or —CF₃, R represents —CH₃, —C₂H₅, or 'C₃H_{7,} and M represents an alkali metal.

5. An electrolyzer comprising the ion exchange membrane according to claim 1.

6. An electrolyzer comprising the ion exchange membrane according to claim 2.

7. An electrolyzer comprising the ion exchange membrane according to claim 3.

8. An electrolyzer comprising the ion exchange membrane according to claim 4.
